(19) United States
(12) Patent Application Publication
(10) Pub. No.: US 2025/0069143 A1
(43) Pub. Date: Feb. 27, 2025

(54) PREDICTING FINANCIAL METRICS

(71) Applicant: Royal Bank of Canada, Toronto (CA)

(72) Inventors: Michael RITACCO, London (CA); Varshitha SERALATHAN, Toronto (CA); Kallie HUYNH, Edmonton (CA); Emily LAO, Toronto (CA); Peter CHOW, Toronto (CA); David WANG, Toronto (CA); Kartik KAUSHIK, Jersey City, NJ (US); Frederic CHANFRAU, Jersey City, NJ (US); Saumitra PANDE, Cambridge, MA (US); Nurani RAHMAN, Toronto (CA); Sankat PATEL, Chicago, IL (US); Karen CROWE, Bloomfield, NJ (US)

(21) Appl. No.: 18/808,859

(22) Filed: Aug. 19, 2024

Related U.S. Application Data
(60) Provisional application No. 63/534,295, filed on Aug. 23, 2023.

(51) Int. Cl. G06Q 40/06

(52) U.S. Cl. CPC G06Q 40/06

(57) ABSTRACT

A future financial metric is predicted using one or more computer processors. A financial metric prediction request is received from a user. Based on the financial metric prediction request, financial data is obtained. The financial data is inputted to one or more trained machine learning models. Using the one or more trained machine learning models, one or more preliminary predictions of the future financial metric are outputted. The one or more preliminary predictions of the future financial metric are inputted to a regression model. Using the regression model, a prediction of the future financial metric is generated.

### FIELD

The present disclosure relates to data processing and in particular to methods and systems for predicting financial metrics, such as future cash flow.

### BACKGROUND

Cash flow forecasting is an important component of financial planning within a financial services business, and is used to optimize financial resources and make informed decisions involving billions of dollars. However, existing cash management tools lack visualization capabilities and efficient means of querying data.

### SUMMARY

According to a first aspect of the disclosure, there is provided a method of predicting a future financial metric, comprising using one or more computer processors to: receive, from a user, a financial metric prediction request; obtain, based on the financial metric prediction request, financial data; input the financial data to one or more trained machine learning models; output, using the one or more trained machine learning models, one or more preliminary predictions of the future financial metric; input the one or more preliminary predictions of the future financial metric to a regression model; and generate, using the regression model, a prediction of the future financial metric.

The regression model may be a ridge regression model.

The financial metric may be one or a combination selected from: accounts receivable; free cash flow; accounts payable; and total revenue.

The one or more trained machine learning models may be one, or any combination, of: an Autoregressive Integrated Moving Average (ARIMA) model; a Seasonal Autoregressive Integrated Moving Average (SARIMA) model; a Prophet model; and an Exponential Smoothing (ES) model.

The one or more trained machine learning models may consist of one of each of: the ARIMA model; the SARIMA model; the Prophet model; and the ES model.

The financial data may include financial data from a business associated with the user and financial data from one or more other businesses not associated with the user.

Receiving the financial metric prediction request may comprise: receiving a natural language financial metric prediction request; inputting the natural language financial metric prediction request to a natural language processor; and generating, using the natural language processor, a Structured Query Language (SQL) query.

Obtaining, based on the financial metric prediction request, the financial data may comprise: querying, using the SQL query, one or more databases; and obtaining, from the one or more databases, the financial data.

Generating, using the natural language processor, the SQL query may comprise using a Parsing Incrementally for Constrained Auto-Regressive Decoding (PICARD) model to generate the SQL query.

The method may further comprise, using the one or more computer processors, displaying, to the user, the prediction of the future financial metric.

The method may further comprise, using the one or more computer processors: receiving one or more adjustments to one or more metrics relating to the financial data; adjusting, based on the one or more adjustments, a Cash Conversion Cycle (CCC) metric; and displaying, to the user, the adjusted CCC metric, wherein the one or more metrics relating to the financial data comprise one, or any combination, of: a Days Inventory Outstanding (DSO) metric; a Days Payable Outstanding (DPO) metric; and a Days Sales Outstanding (DSO) metric.

According to a further aspect of the disclosure, there is provided a non-transitory, computer-readable medium storing computer program code configured, when read by one or more computer processors, to cause the one or more computer processors perform a method comprising: receive, from a user, a financial metric prediction request; obtain, based on the financial metric prediction request, financial data; input the financial data to one or more trained machine learning models; output, using the one or more trained machine learning models, one or more preliminary predictions of the future financial metric; input the one or more preliminary predictions of the future financial metric to a regression model; and generate, using the regression model, a prediction of the future financial metric.

According to a further aspect of the disclosure, there is provided a method of generating for display a Cash Conversion Cycle (CCC) metric, comprising using one or more computer processors to: obtain financial data; receive, from a user, one or more adjustments to one or more metrics relating to the financial data; adjust, based on the one or more adjustments, a Cash Conversion Cycle (CCC) metric; and display to the user the adjusted CCC metric, wherein the one or more metrics relating to the financial data comprise one, or any combination, of a Days Inventory Outstanding (DSO) metric; a Days Payable Outstanding (DPO) metric; and a Days Sales Outstanding (DSO) metric.

According to a further aspect of the disclosure, there is provided a non-transitory, computer-readable medium storing computer program code configured, when read by one or more computer processors, to cause the one or more computer processors perform a method comprising: obtaining financial data; receiving, from a user, one or more adjustments to one or more metrics relating to the financial data; adjusting, based on the one or more adjustments, a Cash Conversion Cycle (CCC) metric; and displaying to the user the adjusted CCC metric, wherein the one or more metrics relating to the financial data comprise one, or any combination, of: a Days Inventory Outstanding (DSO) metric; a Days Payable Outstanding (DPO) metric; and a Days Sales Outstanding (DSO) metric.

This summary does not necessarily describe the entire scope of all aspects. Other aspects, features, and advantages will be apparent to those of ordinary skill in the art upon review of the following description of specific embodiments.

### BRIEF DESCRIPTION OF THE DRAWINGS

Embodiments of the disclosure will now be described in detail in conjunction with the accompanying drawings of which:

FIG. 1 depicts a computer network that comprises a system for predicting cash flow, according to an embodiment of the disclosure.

FIG. 2 is a block diagram of a server comprised in the system depicted in FIG. 1, according to an embodiment of the disclosure.

FIG. 3A is a flow diagram of a method of predicting cash flow, according to an embodiment of the disclosure.

FIG. 3B is a flow diagram of a method of generating an SQL query to obtain financial data from one or more databases, according to an embodiment of the disclosure.

FIG. 4 is a block diagram of various software and hardware components used for predicting cash flow, according to an embodiment of the disclosure.

FIG. 5 is a flow diagram of a method of predicting cash flow, according to an embodiment of the disclosure.

FIG. 6 is a flow diagram depicting a user's interaction with a user interface associated with a system for predicting cash flow, according to an embodiment of the disclosure.

FIG. 7 is an example of a graphical display on a user interface of a forecasted financial metric, according to an embodiment of the disclosure.

### DETAILED DESCRIPTION

The present disclosure seeks to provide improved methods and systems for predicting financial metrics. While various embodiments of the disclosure are described below, the disclosure is not limited to these embodiments, and variations of these embodiments may well fall within the scope of the disclosure which is to be limited only by the appended claims.

Generally, according to embodiments of the disclosure, there are described methods and systems that may allow a user to better visualize their company's cash position. Embodiments of the disclosure may allow users to interactively explore up-to-date financial data and help users make financial decisions based on such data. For example, natural language queries inputted by a user may undergo context-dependent text-to-SQL parsing to ensure schema validation for efficient data retrieval. Therefore, instead of users having to go through multiple platforms or APIs (Application Programming Interfaces) to retrieve and consolidate data needed to generate the cash flow prediction, the user may simply provide a natural language input (e.g., text or speech), and the relevant financial data may then be consolidated and provided to them for easy download and subsequent use in cash flow and balance predictions.

Generally, large companies and corporations, such as financial services institutions, do not leverage public financial data for their cash management services. However, in order to predict one or more financial metrics, embodiments of the disclosure may use both public data (e.g., publicly-available financial statements (e.g., 10-K and 10-Q reports) for companies (such as Fortune 500 companies) across a number of industries and sectors) and a company's own private financial data. Therefore, data from multiple different sources (e.g., financial data both from within and external to the financial services institution) may be used to provide increased accuracy in cash flow forecasting.

According to some embodiments, the cash flow prediction is performed by inputting the financial data to a group (otherwise known as an ensemble) of machine learning models, each serving to capture varying patterns and/or trends within the data. According to some embodiments, the following machine learning models are used: an Autoregressive Integrated Moving Average (ARIMA) model; a Seasonal Autoregressive Integrated Moving Average (SARIMA) model; the Prophet model (developed by Meta); and an Exponential Smoothing (ES) model. These models may also be referred to as times series models. As the ensemble of machine learning models is fitted to the financial data, each model's parameters are then fine-tuned to produce an optimal forecast. In particular, each model automatically conducts a grid search for hyper-parameter tuning. The ARIMA and SARIMA models use the Akaike Information Criterion (AIC) for a stepwise search, while the Prophet and ES models automatically optimize their parameters to fit the data. This automated search allows the models to self-optimize, adapting to the specificities of the data. The ensemble of models exhibits high adaptability and robustness, and is capable of accommodating a range of financial metrics in order to generate accurate forecasts.

According to some embodiments, the outputs from these time-series models are then used as inputs in a ridge regression meta-learning model which is responsible for the generation of the final cash flow forecast. The ridge regression model is similar to a linear regression model in that it attempts to minimize the difference (“training error”) between the model's predictions and the actual values of the training data. The ridge regression model achieves this by using a loss function and adjusting the parameters of the model until the error is minimized. One difference between a ridge regression model and a linear regression model is that the ridge regression model has a more significant penalty on larger parameter values. This causes the ridge regression model to generally favour smaller parameter values but also makes the ridge regression model less likely to overfit to the data.

Furthermore, according to some embodiments, users may explore different Cash Conversion Cycle (CCC) scenarios by adjusting one or more of the following parameters or metrics associated with the financial data:
1. Days Inventory Outstanding (DIO) (e.g., “inventory accounts”);
2. Days Payable Outstanding (DPO) (e.g., “accounts payable”); and
3. Days Sales Outstanding (DSO) (e.g., “accounts receivable”).
   Changes in DSO, DIO, and DPO may therefore be incorporated into the calculation of the company's CCC. CCC is a metric indicating the efficiency of a company's working capital management. The forecasted changes in CCC and their cash effects may be reflected in the global cash effect, enabling a complete view of potential future cash positions under varying scenarios. As a result, multiple, different financial outcomes may be compared and contrasted, by determining differences in cash position under varying business conditions and based on a financial outlook of not only the user's business but also those of its competitors. The ability to simulate various scenarios based on changes in the above parameters may provide businesses with a competitive advantage by allowing them to better anticipate and plan for different possible financial outcomes.

As also described above, natural language input may be converted into SQL queries using a suitable natural language processor. For example, the natural language processor may use a PICARD (Parsing Incrementally for Constrained Auto-Regressive Decoding) model, further details of which may be found at Scholak, T., Schucher, N., & Bahdanau, D. (2021), PICARD: Parsing Incrementally for Constrained Auto-Regressive Decoding from Language Models, Proceedings of the 2021 Conference on Empirical Methods in Natural Language Processing, which is herein incorporated by reference in its entirety.

By using large pre-trained language models (such as the PICARD model) with a database schema (i.e., the table names and column names used to create the SQL query), simple and effective constrained decoding may be provided. Furthermore, the SQL query generated by the model is generally always syntactically correct and valid, and therefore will generally always produce a result instead of an execution error.

According to some embodiments, the generated SQL commands are used to retrieve desired financial or other data from financial databases. Furthermore, the natural language processor can detect and correct spelling errors in keywords, table, or column names based on the given database schema.

The PICARD model has multiple parsing modes, namely:
1. off (no checking)
2. lexing
3. parsing without guards
4. parsing with guards

According to some embodiments, the fourth mode (parsing with guards) is used to reject a wrong prediction. A prediction that passes this mode passes the other three modes (in other words, if the predicted SQL query is validated by the “parsing with guards” mode of the model, then the predicted SQL query will automatically be valid for all other modes of the model). The PICARD model uses the database schema (i.e., the table and column names) to restrict the query prediction and to detect spelling errors. In particular, the PICARD model, based on the natural language query, predicts the SQL query based on the language model and the database schema. The SQL query is then used to query the database and create a preview of a file for the user. The file can then be downloaded and used for further processing.

As can be seen, as part of predicting one or more financial metrics, embodiments of the disclosure allow for the integration of both publically-available data and private data, the use of personalized and adaptable forecasting models, the ability to perform scenario modelling, and the use of natural language processing for data retrieval. These features may provide users (such as the treasurer of a financial services institution) with a comprehensive, easy-to-use, and highly effective tool for managing their company's cash position.

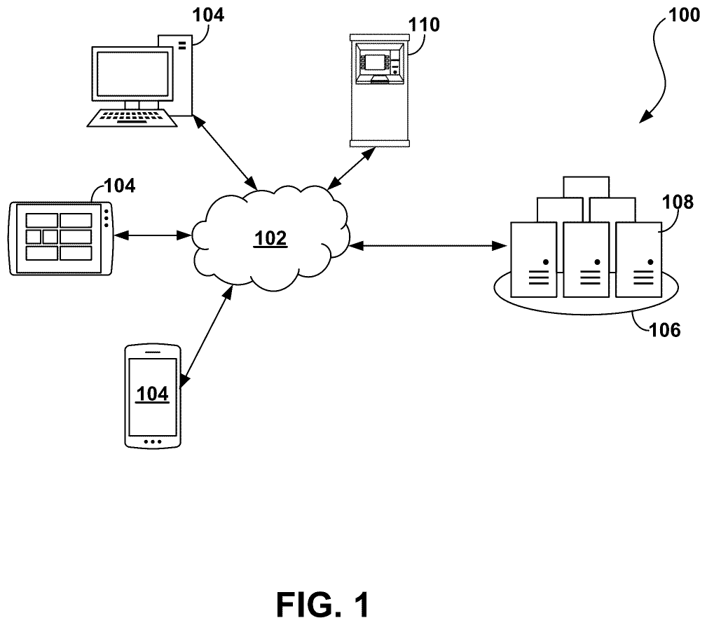

Referring now to FIG. 1, there is shown a computer network 100 that comprises an example embodiment of a system 100 for predicting cash flow. More particularly, computer network 100 comprises a wide area network 102 such as the Internet to which various user devices 104, an ATM 110, and a data center 106 are communicatively coupled. Data center 106 comprises a number of servers 108 networked together to collectively perform various computing functions. For example, in the context of a financial institution such as a bank, data center 106 may host online banking services that permit users to log in to servers 108 using user accounts that give them access to various computer-implemented banking services, such as online fund transfers. Furthermore, individuals may appear in person at ATM 110 to withdraw money from bank accounts controlled by data center 106.

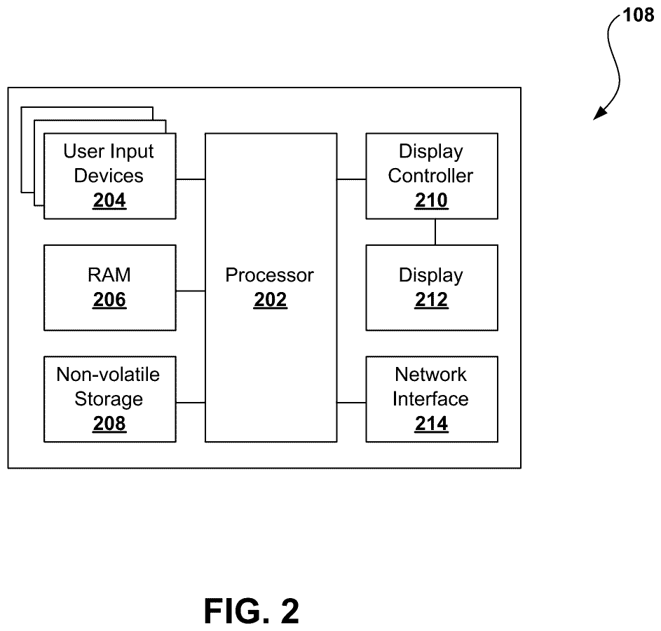

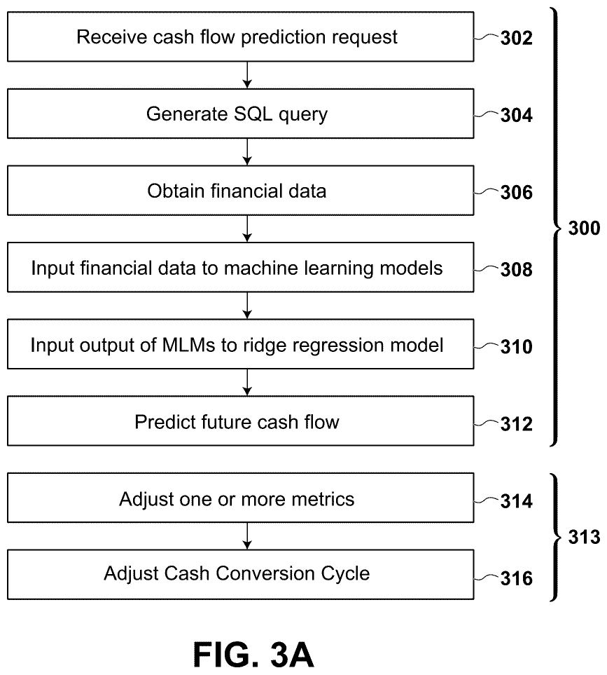

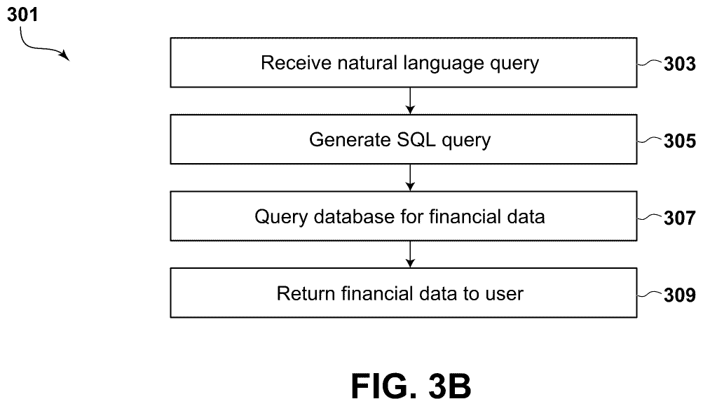

Referring now to FIG. 2, there is depicted an example embodiment of one of the servers 108 that is comprised in data center 106. The server 108 comprises a processor 202 that controls the server 108's overall operation. Processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with wide area network 104 and the other servers 108 in the data center 106. Non-volatile storage 208 has stored on it computer program code that is loaded into RAM 206 at runtime and that is executable by processor 202. When the computer program code is executed by processor 202, processor 202 causes the server 108 to implement a method for predicting cash flow, such as is described in more detail in connection with FIGS. 3A-7 below. Additionally or alternatively, servers 108 may collectively perform the method for predicting cash flow using distributed computing. While the system depicted in FIG. 2 is described specifically in respect of connection with one of the servers 108, analogous versions of the system may also be used for user devices 104.

Referring now to FIG. 3A, there is shown a flow diagram of a method 300 of predicting cash flow, according to an embodiment of the disclosure.

At block 302, a cash flow prediction request is received from a user. For example, a user, using a user input device 204, may enter a natural language query that is passed to processor 202 of server 108. The cash flow prediction request also specifies the particular financial metric that the user wishes to forecast, such as accounts receivable, free cash flow, accounts payable, and total revenue.

At block 304, the natural language query is converted into an SQL query, as described in further detail below.

At block 306, financial data from one or more sources is obtained, using the SQL query to extract the relevant financial data from the one or more sources. The financial data may include, for example, private financial statements relating to the user's business. The financial data may additionally include publically-available financial data, such as financial statements relating to one or more other businesses, such as competitors to the user's own business.

At block 308, the financial data is used as an input to one or more trained machine learning models configured to predict future cash flow based on the financial data obtained at block 306.

At block 310, the output of each of the one or more trained machine learning models is provided to a ridge regression meta-learning model.

At block 312, the ridge regression meta-learning model generates a prediction of the future cash flow of the user's business.

FIG. 3A also shows a flow diagram of a general method 313 of adjusting a cash conversion cycle (CCC) and visualizing how this may impact a global cash effect, according to an embodiment of the disclosure.

At block 314, one or more metrics, such as one or more of a DIO metric, a DPO metric, and a DSO metric, are adjusted, to simulate different possible business scenarios.

At block 316, a CCC is adjusted based on the one or more adjusted metrics. The impact that the adjusted CCC may have on global cash effect may also be displayed, as described in further detail below.

Referring now to FIG. 3B, there is shown a flow diagram of a method 301 of generating an SQL query to obtain financial data from one or more databases, according to an embodiment of the disclosure.

At block 303, a request for financial metric data is inputted by a user. For example, a user, using a user input device 204, may enter a natural language query that is passed to processor 202 of server 108. The requested financial metric data may be cash flow data or data relating to some other financial metric, such as revenue.

At block 305, the natural language query is converted into an SQL query, as described in further detail below.

At block 307, the SQL query is used to query one or more financial databases for the requested data.

At block 309, the requested financial data is returned to the user.

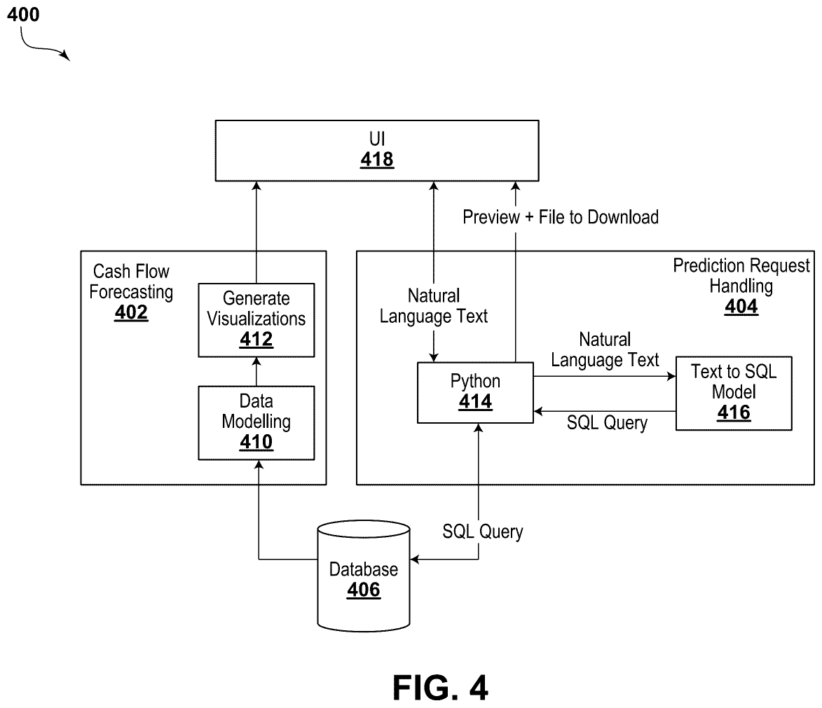

Turning to FIG. 4, there is shown a block diagram of various software and hardware components of a system 400 used for predicting cash flow, according to an embodiment of the disclosure.

System 400 includes a cash flow forecasting component 402, a prediction request handling component 404, and a user interface component 418. A user may provide natural language input to prediction request handling component 404 by interacting with interface component 418. The natural language input is passed to a Python module 414. Python module 414 is configured to read the configuration file for the database schema, as well as store previous queries received during the same session for context. Python module 414 loads a pre-trained Text-to-SQL (PICARD) model 416 which generates, based on the data in the configuration file and based on the natural language input, a corresponding SQL query which is returned to Python module 414. The SQL query is then used by Python module 414 to fetch the requested data from one or more databases 406. Database 406 stores the overall company financial data. Other cash management data such as transactions, deposits, loans, and investments may also be stored in database 406.

The requested data may include financial data relating to the user's business as well as financial data relating to other companies. The data that is extracted from database 406 is passed to Python module 414 which then returns the data to the user, for example in the form of a preview table and a downloadable.csv file.

At blocks 410 and 412 which form part of cash flow forecasting component 402, various models 410 (as described in further detail below) are used for cash flow forecasting. Based on the outputs of these models, visualizations 412 are created and displayed using UI 418. Users can interact with the visualizations to analyze different scenarios on cash conversion cycle accounts.

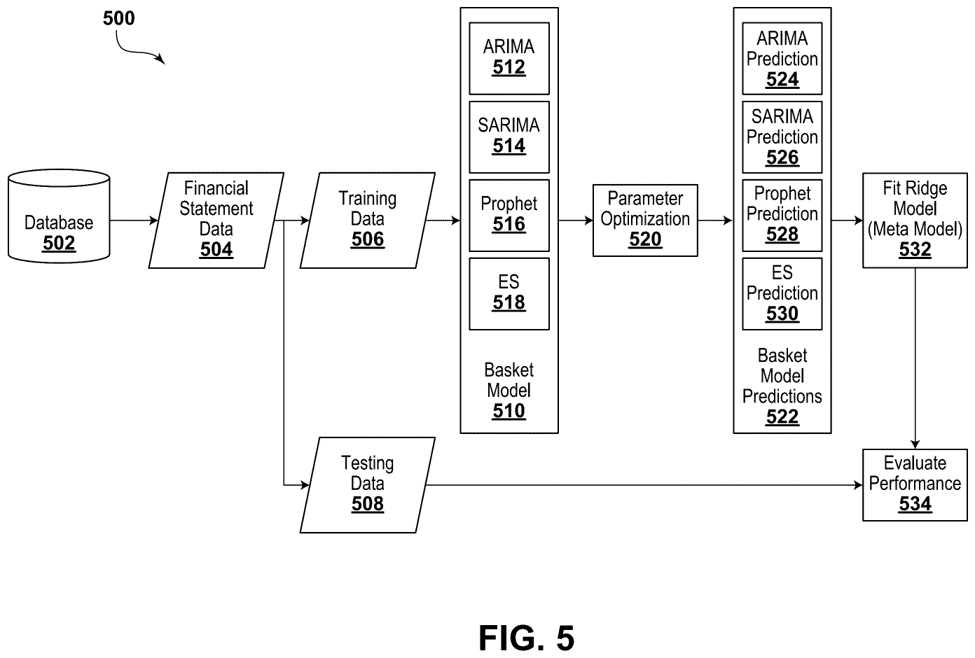

As now described in further detail below in connection with FIG. 5, cash flow forecasting component 402 operates using an ensemble of machine learning models, and in particular ARIMA, SARIMA, Prophet, and ES models.

### ARIMA (Autoregressive Integrated Moving Average)

This model offers robustness in handling data that exhibits trends and irregularities. The model leverages historical data points and differences between these points to forecast future values.

### SARIMA (Seasonal Autoregressive Integrated Moving Average)

An extension of ARIMA, SARIMA adds the capability to handle seasonality in the data, a common occurrence in financial data where patterns repeat over a specific period.

### Prophet

Prophet can handle large amounts of data with multiple seasonality and irregular trends. Prophet is an additive regression model with interpretable parameters that can accommodate usual patterns in time series data, such as seasonality and holidays.

### ES (Exponential Smoothing)

ES is a holistic forecasting method that addresses trend and seasonality in time series data. As such, ES is particularly valuable when working with data that exhibits clear seasonal patterns or trends.

According to some embodiments, other types of models may be used as part of the cash flow prediction, such as an Error, Trend, Seasonality (ETS) model. According to some embodiments, a subset (e.g., one or more) of the models listed above may be used.

Turning now to FIG. 5, there is shown a flow diagram of a method 500 of predicting cash flow, according to an embodiment of the disclosure. FIG. 5 also shows the training of the ensemble of machine learning models that receive the financial data to predict the future cash flow.

At blocks 502 and 504, financial data (e.g., data from various financial statements) is extracted from one or more databases. For example, the financial data may include financial data from the user's business as well as financial statement data from various other companies such as Fortune 500 companies. At block 506, the extracted financial data is converted into training data depending on the specific metric that is to be forecasted. According to some embodiments, the metrics that may be forecasted are one or more of the following: accounts receivable, free cash flow, accounts payable, and total revenue. In particular, depending on the specific metric that the user wishes to forecast, the data containing that metric's value over time is extracted from the financial statement data, and the models are fitted to this extracted data. For example, if free cash flow is selected to be forecasted, then at block 506 only the data contained in the columns for free cash flow (with a time index) would be used as training data.

The training data is then inputted to a number of different machine learning models in an ensemble 510 of machine learning models, including an ARMIA model 512, a SARIMA model 514, a Prophet model 516, and an ES model 518. Each model in ensemble 510 attempts to capture the temporal pattern in the data by fitting to it. In this context, “fitting” means to reduce the prediction error of the model over the set of training data. The result of fitting each model to the data produces estimates of each model's hyper-parameters which represent the values of the coefficients the model uses when predicting new future instances. For example, for a simple linear regression model, the hyper-parameters are the slope and intercept which minimize the sum of residuals (the sum of prediction errors over the set of training data).

After the optimal parameters for each model have been determined (block 520), the predictions are extracted from each model. As can be seen, ARIMA model 512 outputs an ARIMA prediction 524, SARIMA model 514 outputs a SARIMA prediction 526, Prophet model 516 outputs a Prophet prediction 528, and ES model 518 outputs an ES prediction 530. These predictions are then used as input features for a further model: a ridge regression model. In this configuration, the ridge regression model is known as a meta-learning model. A meta-learning model is a machine learning model which takes the outputs of other machine learning models as its input. Therefore, the ridge regression model is trained on the outputs of ensemble 510, and at block 532 combines predictions 524, 526, 528, and 530 into a single, more accurate forecast. The output of ridge regression model is the forecast of the selected financial metric.

The performance of ridge regression model may be validated on a test dataset (block 508) to ensure its predictive accuracy and reliability. For example, to assess the model's predictive power, the Mean Absolute Percentage Error (MAPE) may be selected. The MAPE criterion measures the mean of all absolute percentage errors between the predicted and actual values. In other words, MAPE is related to the inverse of a model's accuracy. For example, if a model's MAPE is 10%, then the predictions are on average 10% away from the actual values they are aiming for. Generally, a MAPE at or below 20% indicates a model fits the data well.

To ensure the MAPE score of the model provides a reliable gauge of the model's performance, an expanding cross-validated time series may be used. By cross-validating when estimating the model's performance, the risk of over-fitting and producing an artificially-inflated MAPE score may be reduced.

Depending on the cash flow prediction, the system may recommend one or more actions/products to the user. For example, if the models anticipate cash flow being poor, the system may recommend a credit line or other credit solution. If the cash flow is predicted to be strong, the system may recommend one or more investment products.

This ensemble-based, meta-learning approach may ensure robustness and adaptability in cash flow forecasting, by leveraging the strengths of multiple models and by adjusting to the various trends across different financial metrics of multiple different public companies, such as Fortune 500 companies.

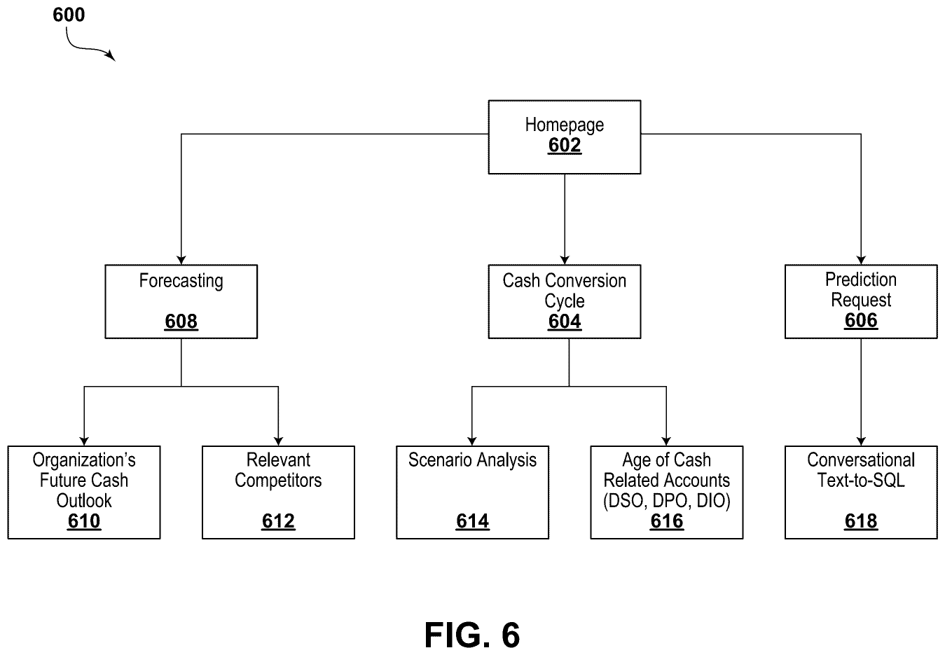

Turning to FIG. 6, there is shown a flow diagram depicting a user's interaction with a user interface associated with a system for predicting cash flow, according to an embodiment of the disclosure.

A user may navigate from a homepage 602 to any of a forecasting page 608, a cash conversion cycle page 604, and a prediction request page 606.

At forecasting page 608, the user may review cash flow predictions and outlooks for their own company (block 610) as well as for those of their competitors (block 612).

At cash conversion cycle page 604, a scenario analysis tool 614 may be used to dynamically update graphs to show differences in cash position as the user, at block 616, adjusts one or more of a Days Inventory Outstanding metric, a Days Sales Outstanding metric, and a Days Payable Outstanding metric.

At prediction request page 606, the text-to-SQL model with spell-check allows users to input cash flow prediction queries in natural language. As describe above, the natural language queries are converted into SQL format and are used to extract relevant financial data for the cash flow prediction. The financial data may be downloaded in.csv format.

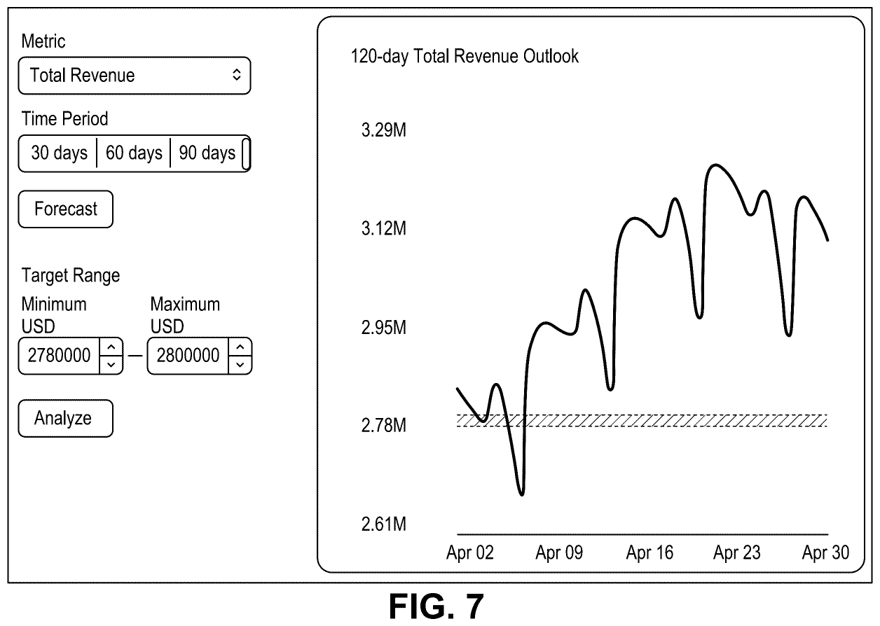

FIG. 7 shows an example graphical representation of a forecasted financial metric, with the forecast having been generated using the methods described herein. As can be seen, total revenue has been selected as the financial metric to be forecasted, and the forecast is illustrated by the plot on the right-hand side of the user interface.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” are intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Any of the processors used in the foregoing embodiments may comprise, for example, a processing unit (such as a processor, microprocessor, or programmable logic controller) or a microcontroller (which comprises both a processing unit and a non-transitory computer readable medium). Examples of computer-readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

1. A method of predicting a future financial metric, comprising using one or more computer processors to:
receive, from a user, a financial metric prediction request;
obtain, based on the financial metric prediction request, financial data;
input the financial data to one or more trained machine learning models;
output, using the one or more trained machine learning models, one or more preliminary predictions of the future financial metric;
input the one or more preliminary predictions of the future financial metric to a regression model; and
generate, using the regression model, a prediction of the future financial metric.

2. The method of claim 1, wherein the regression model is a ridge regression model.

3. The method of claim 1, wherein the financial metric is one or a combination selected from: accounts receivable; free cash flow; accounts payable; and total revenue.

4. The method of claim 1, wherein the one or more trained machine learning models are one, or any combination, of:
an Autoregressive Integrated Moving Average (ARIMA) model;
a Seasonal Autoregressive Integrated Moving Average (SARIMA) model;
a Prophet model; and
an Exponential Smoothing (ES) model.

5. The method of claim 4, wherein the one or more trained machine learning models consist of one of each of:
the ARIMA model;
the SARIMA model;
the Prophet model; and
the ES model.

6. The method of claim 1, wherein the financial data includes financial data from a business associated with the user and financial data from one or more other businesses not associated with the user.

7. The method of claim 1, wherein receiving the financial metric prediction request comprises:
receiving a natural language financial metric prediction request;
inputting the natural language financial metric prediction request to a natural language processor; and
generating, using the natural language processor, a Structured Query Language (SQL) query.

8. The method of claim 7, wherein obtaining, based on the financial metric prediction request, the financial data comprises:
querying, using the SQL query, one or more databases; and
obtaining, from the one or more databases, the financial data.

9. The method of claim 7, wherein generating, using the natural language processor, the SQL query comprises using a Parsing Incrementally for Constrained Auto-Regressive Decoding (PICARD) model to generate the SQL query.

10. The method of claim 1, further comprising, using the one or more computer processors:
displaying, to the user, the prediction of the future financial metric.

11. The method of claim 1, further comprising, using the one or more computer processors:
receiving one or more adjustments to one or more metrics relating to the financial data;
adjusting, based on the one or more adjustments, a Cash Conversion Cycle (CCC) metric; and
displaying, to the user, the adjusted CCC metric,
wherein the one or more metrics relating to the financial data comprise one, or any combination, of:
a Days Inventory Outstanding (DSO) metric;
a Days Payable Outstanding (DPO) metric; and
a Days Sales Outstanding (DSO) metric.

12. A non-transitory, computer-readable medium storing computer program code configured, when read by one or more computer processors, to cause the one or more computer processors perform a method comprising:
receive, from a user, a financial metric prediction request;
obtain, based on the financial metric prediction request, financial data;
input the financial data to one or more trained machine learning models;
output, using the one or more trained machine learning models, one or more preliminary predictions of the future financial metric;
input the one or more preliminary predictions of the future financial metric to a regression model; and
generate, using the regression model, a prediction of the future financial metric.

13. A method of generating for display a Cash Conversion Cycle (CCC) metric, comprising using one or more computer processors to:
obtain financial data;
receive, from a user, one or more adjustments to one or more metrics relating to the financial data;
adjust, based on the one or more adjustments, a Cash Conversion Cycle (CCC) metric; and
display to the user the adjusted CCC metric,
wherein the one or more metrics relating to the financial data comprise one, or any combination, of
a Days Inventory Outstanding (DSO) metric;
a Days Payable Outstanding (DPO) metric; and
a Days Sales Outstanding (DSO) metric.

14. A non-transitory, computer-readable medium storing computer program code configured, when read by one or more computer processors, to cause the one or more computer processors perform a method comprising:
obtaining financial data;
receiving, from a user, one or more adjustments to one or more metrics relating to the financial data;
adjusting, based on the one or more adjustments, a Cash Conversion Cycle (CCC) metric; and
displaying to the user the adjusted CCC metric,
wherein the one or more metrics relating to the financial data comprise one, or any combination, of:
a Days Inventory Outstanding (DSO) metric;
a Days Payable Outstanding (DPO) metric; and
a Days Sales Outstanding (DSO) metric.
